(19) United States
(12) Patent Application Publication
(10) Pub. No.: US 2021/0362270 A1
(43) Pub. Date: Nov. 25, 2021

(54) Laser Ablation and Laser Processing Fume and Contaminant Capture System

(71) Applicant: G.C. Laser Systems, Inc., Forest Park, IL (US)

(72) Inventors: Bartosz Andrzej Dajnowski, Oak Brook, IL (US); Magdalena Dajnowski, Oak Brook, IL (US)

(21) Appl. No.: 17/323,704

(22) Filed: May 18, 2021

Related U.S. Application Data
(60) Provisional application No. 63/027,785, filed on May 20, 2020.

(51) Int. Cl. B23K 26/12; B23K 26/082; B23K 26/70; B23K 26/36; B23K 26/16

(52) U.S. Cl. CPC B23K 26/127; B23K 26/1224; B23K 26/082; B23K 26/16; B23K 26/703; B23K 26/36; B23K 26/123

(57) ABSTRACT

Laser ablation and laser processing fume and contaminant capture systems are disclosed herein. An example system includes a housing forming a partial enclosure that is configured to be placed against a target surface, a transparent window being integrated into a top surface of the housing, the transparent window being configured to allow for the transmission of a laser scan pattern to the target surface, and an outlet port for establishing a negative pressure inside the housing. Air is drawn into the housing through a first inlet port, the air carries contaminants created during ablation of the target surface by the laser scan pattern out of the outlet port.

### CROSS-REFERENCE TO RELATED APPLICATIONS

This application claims the benefit and priority of U.S. Provisional Application Ser. No. 63/027,785, filed on May 20, 2020, which is hereby incorporated by reference herein in its entirety, including all references and appendices cited therein, for all purposes, as if fully set forth herein.

### FIELD

The present disclosure pertains to the laser ablation systems and methods, and in some instances to laser ablation fume and contaminant capturing systems. Example systems can capture hazardous materials and fumes created by laser ablation and laser processing to protect the environment, people, and laser equipment from exposure to these materials and fumes

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of an example fume extractor apparatus of the present disclosure, in use against a target surface.

FIG. 2 is a cross-sectional view of an example fume extractor apparatus in combination with a vacuum system.

FIG. 3 illustrates an example closed-circuit fume extractor apparatus.

FIG. 4 is a cross-sectional view of another example fume extractor apparatus.

FIGS. 5 and 6 collectively illustrate perspective views of yet another example fume extractor apparatus with transparent sides.

FIG. 7 is a perspective view of an example laser scanning system in combination with an example fume extractor apparatus.

FIGS. 8-10 collectively illustrate perspective views of yet another example fume extractor apparatus with a tubular port.

FIG. 11 is a perspective view of another example fume extractor apparatus having an arcuate shape.

### SUMMARY

One example system includes a housing forming a partial enclosure that is configured to be placed against a target surface; a transparent window being integrated into a top surface of the housing, the transparent window is configured to allow for the transmission of laser output to the target surface; and an outlet port for establishing a negative pressure inside the housing, wherein air is drawn into the housing through a first inlet port, the air carries contaminants created during ablation of the target surface by the laser output, out of the outlet port.

Another example system includes a housing that is configured to be placed against a target surface; a port such as a tubular port being integrated into a surface of the housing, the tubular port being configured to allow for the transmission of laser output to the target surface; and an outlet port for drawing air inside the housing through the tubular port, the air carrying contaminants created during ablation of the target surface by the laser scan pattern out of the outlet port. The port can have other geometric shapes such as square, oval, or polygon.

Yet another example system includes an enclosure having a top surface and sides; a transparent window associated with the top surface, the transparent window allowing transmission of laser output through the transparent window to the target surface; and an outlet port for drawing air into an opening in the housing, the air mixing with and carrying away contaminants created during ablation of the target surface by the laser output.

### DETAILED DESCRIPTION OF EMBODIMENTS

### Overview

Laser ablation/cleaning methods are used to process, alter, clean, or remove a range of unwanted layers of material from various substrates such as contaminants, corrosion, coatings, paint, biological substances, organic substances, toxic substances, and hazardous materials. These methods can also be used to create a texture on a surface or to decontaminate a surface.

The ablated and vaporized materials and contaminants created by the laser ablation process are typically captured by some form of fume extraction system where the fume extractor is positioned in close proximity to the laser process so that the fumes/contaminants are captured as they are removed from the surface by the laser. The fume extractor can be positioned above, next to, below, behind, at an angle to, perpendicular, or parallel to the laser cleaning process. This setup is functional but can have some inherent problems. The fume extractor needs to be positioned correctly to capture the fumes. The fumes are then collected through a series of filters such as HEPA and carbon filters. Problems such as an incorrect position of the fume extractor, strong wind or drafts, insufficient vacuum draw, or an obstruction to the draw or flow of the fumes could potentially allow some of the air-born contaminants to escape collection. Laser ablated particles can also eject off of a surface in all directions and can have more momentum when higher laser powers or higher fluence levels are used during cleaning. This is of particular concern when dealing with hazardous or toxic materials such as carcinogens, lead, radioactive materials, and biologically hazardous materials such as bacteria, mold, or viruses. Another concern is that the laser equipment itself is at risk of being contaminated by any of these air-born materials/contaminants that are not captured by the fume extraction and deposit on the laser equipment itself. The laser system, scanner, optics, robotics, and functional components may get contaminated by laser-ablated hazardous materials which may be time-consuming, expensive, difficult, or in some cases impossible to remove. For example, in the case of nuclear decontamination cleaning of radioactive materials or biohazard cleaning, getting these contaminants on the laser equipment could necessitate the need for disposal or replacement of expensive parts of the equipment or all of the equipment. This present invention remedies several problems such as: ensuring full capture of all laser-ablated/vaporized material, ensuring that expensive laser equipment and laser cleaning system components do not get contaminated by hazardous materials, ensuring personnel operating laser equipment are not exposed to hazardous materials, allowing for easy replacement in the field and continued workflow when dealing with hazardous environments and materials, and the fume capture chamber can be made in a geometric shape that is optimal for cleaning a particular surface or object shape.

The systems and methods disclosed herein provide cost-effective and efficient mechanisms for remediating laser cleaning hazardous materials. Rather than place a fume extraction system near a laser ablation process, the laser ablation process is contained with the system (also referred to as a fume extraction system). This ensures everything is captured and does not escape and contaminants the laser equipment, surroundings, or personnel.

The systems and methods disclosed herein provide cost-effective and efficient mechanisms for remediating laser cleaning materials that are flammable and for laser cleaning and processing materials and surfaces in environments with flammable or combustible materials present in the environment.

The fume extraction design is an enclosed system with a window or windows that the laser fires through to reach the unwanted layer or contaminant that is to be removed while it is in a vacuum negative pressure environment. The portion/face of the chamber that comes in contact with the surface being treated is open to allow the laser beam to reach the surface. This eliminates the risk for any vaporized material escaping collection because it is being ablated within the fume extraction chamber and everything in this space is under vacuum pressure. The fumes and/or contaminants are then collected through an appropriate method such as series of filters such as HEPA and carbon filters or vented out in an appropriate manner.

The laser output is fired into the fume extraction chamber/devise through a window made of an appropriate material that is transparent and does not absorb the wavelength or wavelengths of the laser output. Example laser output can include a laser beam that is pulsed, modulated, or continuous wave and is directed at a surface with optics to one specific area or spot, and/or is directed to a surface with a scanning mechanism to create a scan pattern on that surface.

An example of window material is fused silica, quartz, a polymer such as acrylic, or other optical glass or transparent material. This window could also have an anti-reflective coating for the laser wavelength/s being used. This window could be made to be easily replaceable in case it gets dirty or damaged.

The fume extraction device can be fixed or portable, be directly integrated and attached/connected to the laser scanner, or function as an independent device that can be either operated by hand or an automated process.

The chamber/device is connected to a vacuum hose or conduit or vacuum source directly. Air is allowed to enter the chamber/device through one or more ports/openings that allow air to flow through the system and create a current that moves vaporized material in the desired direction toward collection (e.g, towards an outlet or output port). The surface of the fume extraction system contacts the surface being laser cleaned directly to create a seal against the surface. There can be a rubber liner, gasket, or other appropriate material to help create this seal. Any surface imperfections that do not allow for a perfect seal do not pose a problem to the collection of the vaporized material, as the vacuum of the system will create negative pressure allowing air to only enter and not exit through those gaps. For example, if there were 100 small imperfections in the surface that create gaps in the seal that allow air to pass through, those 100 imperfection areas would act as 50 small inlet vents that only allow air to enter the chamber and not exit due to the negative vacuum pressure inside.

In the case of working with hazardous materials, the fume capture chamber is the only item that gets contaminated during the laser cleaning process and can be easily replaced with a new one. This would be an extremely cost-effective alternative to replacing all or part of a laser cleaning system.

### Example Embodiments

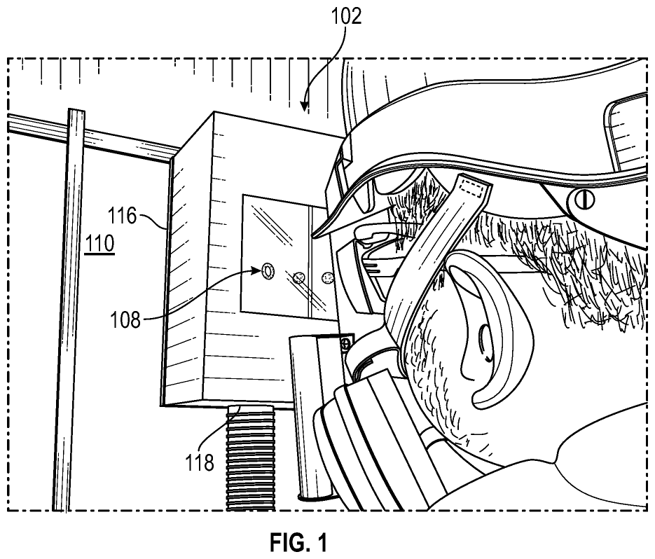

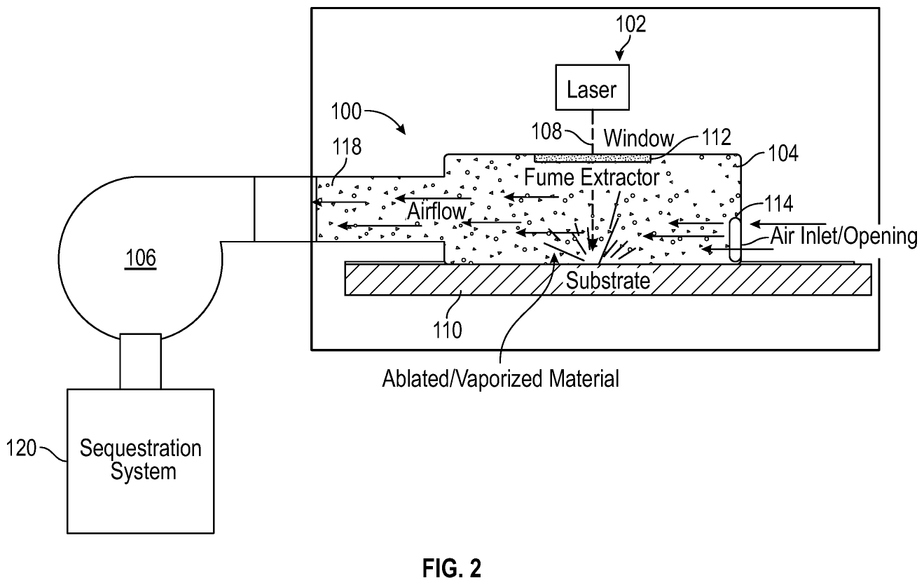

The present disclosure pertains to fume capture systems that enclose a workspace where a laser is being used to ablate a target surface. FIG. 1 illustrates an example fume extractor apparatus (hereinafter “system 100”). The system 100 can be placed onto a target surface 110 that is to be ablated by laser output 108 emitted by a laser scanner (see FIG. 2). In this example, the target surface 110 is a wall that has contaminants on its surface. The laser output 108 can be directed at the target surface 110 to ablate the surface of the wall to remove the contaminants.

The laser output 108 can include any radiation pattern emitted by any laser scanner. Example include laser scanners but are not limited to galvanometer scanners, piezoelectric scanners, polygon scanners, moving or rotating prism-based scanners, rotating optic scanners, circular scanners, and other conventional optical scanning systems that are used to create a pattern with a laser beam for the purpose of ablation or material processing.

In FIGS. 1-3, the system 100 is illustrated in combination with a laser scanning system 102. The system 100 can include a housing 104 that is coupled to a vacuum 106. The laser scanning system 102 produces the laser scan pattern 108 that is directed at a target surface 110. The ablation of a coating on the target surface 110 may produce fumes and other contaminants that are enclosed in the housing 104. The housing 104 can take any shape and/or size, which may depend on the shape/sizing of the target surface 110. Various non-limiting shapes and sizes of other fume capture systems are illustrated and disclosed herein. The housing 104 can be placed in fluid connection with the vacuum 106 through a duct or other conduit. A filtering or other sequestering apparatus can be placed in fluid communication between the housing 104 and the vacuum 106.

The housing 104 can be constructed from any desired material such as metal or plastic, as would be known to one of ordinary skill in the art. The housing 104 is a partial enclosure that is created by a top surface 104A and sides, such as side 104B. The sides define an opening of the enclosure. Thus, the housing 104 is a box that is open on its lower end, where the edges of the sides can contact the target surface 110.

The system 100 can include a window 112 that is constructed from a transparent or at least partially transparent material. The optical attributes of the window 112 can be tuned to the wavelength of the laser scanning system 102, in some embodiments. The window material can be tuned to the wavelength of the laser to prevent any alteration of the laser radiation that would reduce its ablation efficacy. Thus, the laser output can travel through the window 112 without being impeded by the window 112. The window 112 can be made from glass, optical glass, fused silica, quartz, and polymers—just to name a few.

In one embodiment, the window 112 can include an optic, such as a lens that is configured to act as a focus (or other optical enhancement) for the laser scanning system 102. While the window 112 is illustrated on the top surface of the housing 104, the window 112 can be placed on any other surface of the housing 104. In some instances, multiple windows can be placed on one or more of the surfaces of the housing 104. As illustrated and described infra, the housing 104 can be entirely or partially constructed from transparent materials.

In some instances, the window 112 can be removed leaving an opening. The airflow through the housing 104 can be adjusted by changing the operational parameters of the vacuum 106. The airflow can be controlled to reduce a likelihood that contaminants can escape the housing 104 through the opening during ablation. For example, the location, shape, and/or profile of a port or vent of the housing 104 can affect how air and contaminants are drawn away from the opening. Additional details regarding the port or vent are provided in greater detail below.

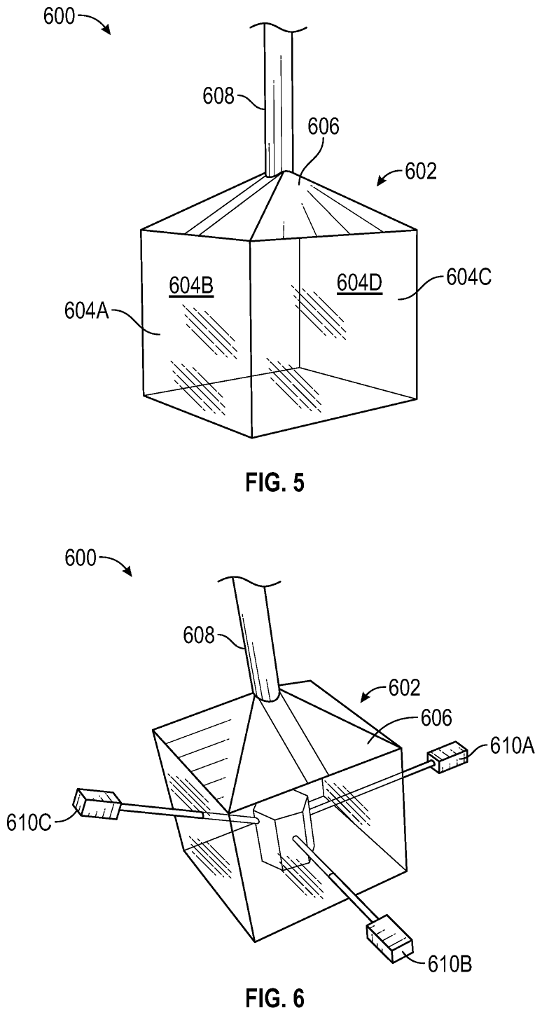

In various embodiments, the housing 104 comprises at least one port or vent 114 that allows air to enter the housing 104 and create a pattern of airflow. The airflow can be tuned not only to direct the fumes and contaminants out of the housing 104 but also to prevent contamination of the window 112. In one example, the vent 114 is an inlet port in the form of an adjustable opening. The vent 114 can comprise a louver or cover that can be adjusted to control the size of the cross-section of the opening and thus change the amount/velocity of airflow entering the housing. An example adjustable opening is also illustrated in the embodiment of FIG. 5. The adjustable opening can be located on a lower end of the housing 104 and on an opposing end of the housing 104 relative to an outlet port 118 that is coupled to the vacuum 106. Due to the negative pressure, air drawn into the vent 114 creates a current of air that passes over the area being laser ablated or laser processed, resulting in potentially beneficial cooling of this area during the process.

In some instances, the dimensions of the vent 114 can be selected to create negative air pressure inside the housing 104, which creates suction between the lower edge of the housing 104 and the target surface 110 when air is drawn by the vacuum 106.

In instances where the target surface 110 is porous, air may be drawn in through the small spaces between the lower edge of the housing 104 and the target surface 110. It will be understood that the airflow pressure created by the vacuum 106 can be adjusted to ensure the proper degree of suction between the housing 104 and the target surface 110. For example, the vacuum 106 can be adjusted to ensure that negative pressure is present inside the housing 104. The negative pressure, if sufficient, can allow the housing to stay in place on the target surface 110 without the user having to hold the housing 104 against the target surface 110. In some instances, the vacuum 106 can couple the system 100 with a sequestration system 120 that can store ablation contaminants for disposal or other treatment.

Lower edges of the sides of the housing 104 can be lined with a gasket or seal 116 (see FIG. 1) that creates an interface between the housing 104 and the target surface 110. In other embodiments, the lower edge of the housing 104 can comprise wheels or roller bearings that allow the system 100 to slide along the target surface 110. The housing 104 can also include magnets or suction-based mounts such as suction cups which help the housing adhere to and/or stay on surfaces.

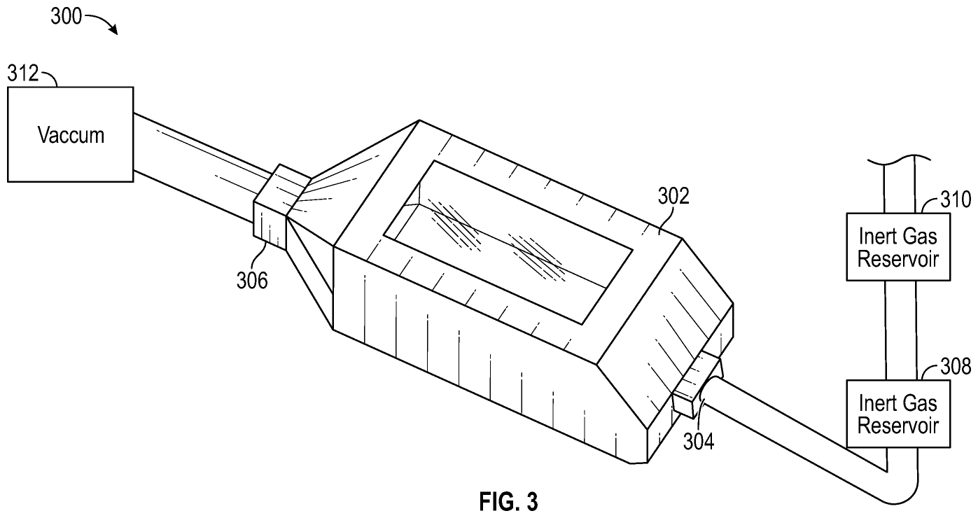

FIG. 3 is a perspective view of another example system 300 that is identical to the system 100 of FIGS. 1-2, with the exception that rather than having a port or vent allowing air to flow into the housing, the system 300 comprises a housing 302 that comprises an inlet conduit 304 and outlet conduit 306, creating a closed circuit in some instances. The inlet conduit 304 can be a hose coupled to an air handler 308. The outlet conduit 306 can be coupled to a vacuum 312, but similar to that of FIGS. 1-2. The inlet conduit 304 can be coupled to an inert gas reservoir 310 that introduces an inert gas, such as argon or nitrogen, into an airstream that is provided to the housing 302 by an air handler 308. The inert gas reservoir 310 can be optional in some closed systems, however, the closed system can include the vacuum 312 and air handler 308, with the system 300 located there between. The air handler 308 can include any device or system configured to provide air and/or inter gas and air mixtures. These devices can include a pump, fan, or other equivalent devices.

The inert gas can reduce ignition and fire that may result from the ignition of volatile chemicals produced during the ablation process. As noted above, when the flow of air out of the system 300 through the outlet conduit 306 is greater than the flow of air into the system 300 through the inlet conduit 304, negative pressure is created inside the housing 302, which allows the housing 302 to attach to a work surface.

The use of this system with or without an inert gas can reduce the risk of fires or explosions in environments where there are flammable or combustible materials present in the environment or air.

Advantageously, the system 300 can capture and collect flammable gases created by laser ablation or laser processing. The system 300 can also contain laser-plasma into a confined area when cleaning in environments that may have explosive or flammable gasses ambiently present (such as in an oil refinery). This helps make the laser ablation process explosion-proof. The addition of an inert gas further reduces ignition potential. While nitrogen and argon have may be utilized, any suitable inert gas can be used. In some embodiments, the inert gas may be used to mix with air or to fully replace air with an inert gas purge. Thus, the inert gas reservoir 310 can mix air into the inert gas. In another embodiment, the inlet conduit 304 could include an air intake member such as a vent or valve that allows air to enter the inlet conduit 304 and mix. In yet another embodiment, a vent in the housing 302 can also draw in air through a one-way valve or other mechanisms.

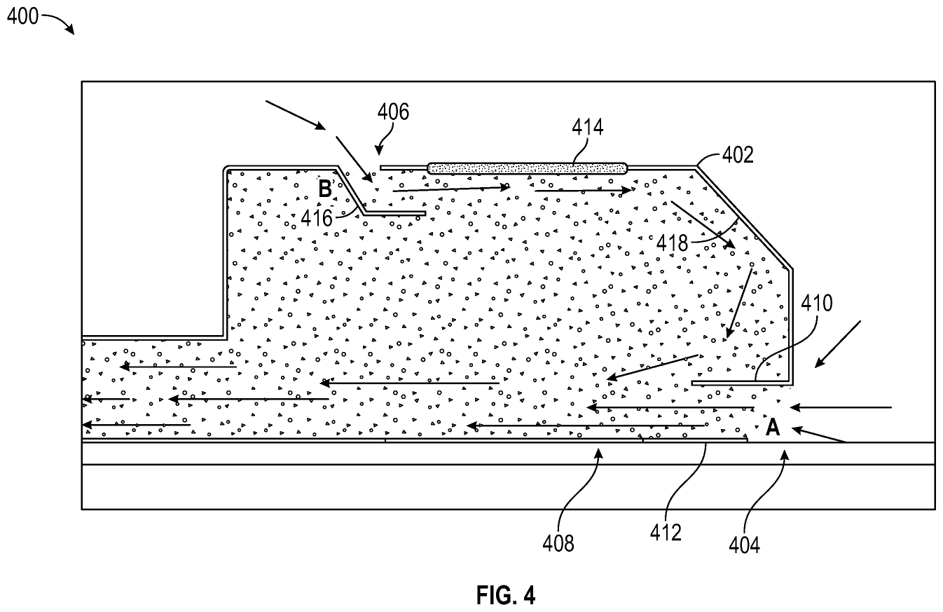

FIG. 4 is a cross-sectional view of another example system 400. The system 400 is similar to the system of FIGS. 1-2, but includes a plurality of ports/openings for air to enter a housing 402. That is, the housing 402 includes a first port 404, a second port 406, and a third port 408. The first port 404 is formed by a lip 410 that is spaced apart from an end of a lower surface 412 the housing 402. The lip 410 and lower surface 412 form a nozzle/conduit that directs air into the housing 402. Again, the shape of the housing 402 can be modified to optimize airflow. The housing 402 could have round faces or other geometric shapes. Additional airflow items such as air knives or fans could be placed inside the chamber to manage airflow and to help keep the process window clean.

In general, the various ports are either always open or open when the system is under vacuum. The location of these ports can be strategically positioned to optimize the path of airflow within the chamber to make sure collection is efficient and this can also serve the added benefit of causing clean incoming air to blow against the inside face window to help keep it clean.

As with the first and second ports 404 and 406, lips/fins/flaps help direct the flow of air into the chamber in a more linear and/or laminar way. This can be a bent piece of metal or flap inside the chamber. One or more of these ports can be used as needed.

The second port 404 is positioned adjacently to a window 414 of the housing 402. An angled ledge 416 directs air into the housing 402. The air is directed by the angled ledge 416 across a lower portion of the window 414 to prevent ablation contaminants from contacting the window 414 and to cool the window 414. Contaminate buildup on the window 414 may reduce the transparency of the window over time, which would lead to poor ablation. An angled surface 418 of the housing 402 may direct the air flowing underneath the window 414 to circulate towards the lower surface 412. The third port 408 aligns with the window 414 and allows a laser to contact a work surface 418.

FIGS. 5-6 collectively illustrate another example system 600. This example system 600 includes a housing 602 comprising a plurality of transparent sides 604A-604D forming a polygon. The housing 602 is capped with a hood 606 that is angled to direct ablation contaminants into an outlet port 608. The outlet port 608 can be coupled to a vacuum (not shown, but similar to that used in FIG. 2). The housing 602 can have any number of sides. In some instances, only a portion of the sides can be transparent. When more than one of the sides is transparent, more than one laser scanning system can be placed near the system 600. In this example, three laser sources or scanning systems 610A-610C are present, although additional or fewer laser sources or laser scanning systems can be utilized. Again, other types of lasers can be used than those illustrated.

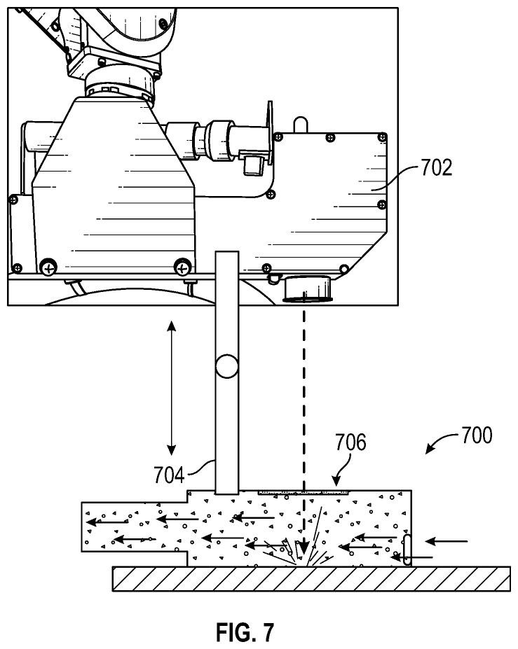

FIG. 7 illustrates another example embodiment of a system that includes a fume extracting system 700 in combination with a laser scanning system 702. The fume extracting system 700 and laser scanning system 702 can be functionally or mechanically coupled to one another using a linkage system 704. The linkage system 704 can be used to selectively distance or space the fume extracting system 700 and laser scanning system 702 from one another. When the fume extracting system 700 includes an optical element in its window 706. The window 706 can function as a focus for the laser scanning system 702. In other embodiments, the window 706 is a transparent element that allows the laser beam to pass therethrough without disturbance.

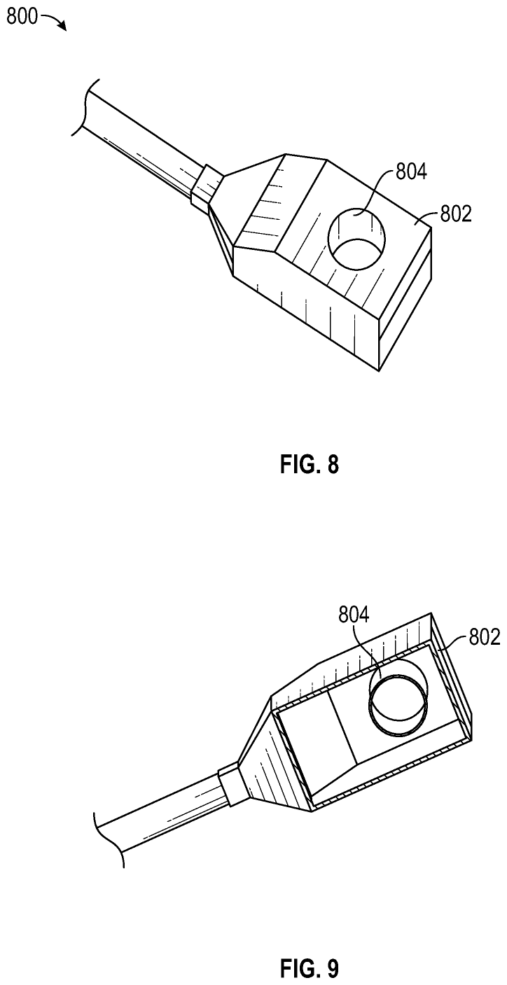

FIGS. 8-10 collectively illustrate another example embodiment of a fume extracting system 800. The system 800 can comprise a housing 802 of any size and/or shape. However, the housing 802 may be taller than that of the system of FIGS. 1-2 to allow for the incorporation of a tubular port 804. In this example, the tubular port 804 has a circular shape, however, the tubular port 804 can have any desired shape.

The length of the tubular port 804 can vary according to design requirements. The tubular port 804 is utilized in lieu of a window, although a window can be included. The tubular port 804 functions as a funnel and may prevent ablation contaminants from escaping the housing 802. Because the tubular port 804 may not be covered by a window, air can enter the tubular port 804 and travel into the housing 802. The movement of the air downwardly through the tubular port 804 prevents contaminants from moving upwardly through the tubular port 804. A laser scanner 806 can direct a laser beam 808 through the tubular port 804 as illustrated in FIG. 10. The tubular port 804 terminates inside the housing 802, allowing air to enter the housing.

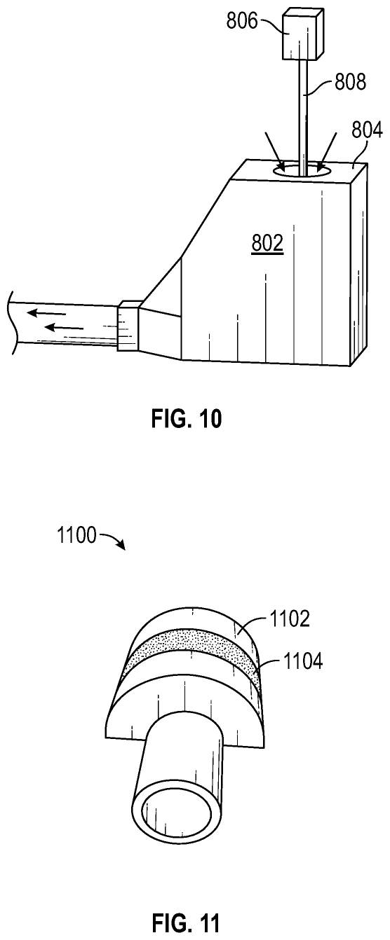

FIG. 11 illustrates another example embodiment of a fume extracting system 1100 that includes a semi-cylindrical housing 1102 with an arcuate window 1104. Although not shown, a lower edge of the housing could be curved to allow the system 1100 to contact a round target surface, such as a pipe. The curve of the housing could be either concave or convex in shape to correspond to the outer or inner sidewall of a pipe, for example. To be sure, the diameter/radius of the housing can vary based on the dimensions of the target surface. In some instances, the fume extracting system could be completely cylindrical to conform to and wrap around a round object, such as a pipe. The laser scanner can move around and fire the beam through the arcuate window to reach a large area within the enclosed fume chamber.

In some embodiments, a plurality of fume extracting systems can be connected in series (such as a daisy-chain) to one another or in an array. The interconnected fume extracting systems can be connected to a single vacuum or pump to facilitate airflow through the fume extracting systems.

While some embodiments have contemplated use in various industrial applications, fume capture systems of the present disclosure can be applied in medical applications. For example, vaporized human or organic material can be sequestered and removed during a laser treatment. For example, a laser can be used to remove a growth from a patient's skin or to remove a tattoo with a tattoo removal laser. Thus, the fume capturing systems disclosed herein can also capture organic-based fumes and airborne materials created during laser medical procedures and laser skin treatments.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers, and/or sections, these elements, components, regions, layers, and/or sections should not necessarily be limited by such terms. These terms are only used to distinguish one element, component, region, layer, or section from another element, component, region, layer, or a section. Thus, a first element, component, region, layer, or section discussed below could be termed a second element, component, region, layer, or section without departing from the teachings of the present disclosure.

The terminology used herein is to describe particular or example embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, and I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A system comprising:
a housing forming a partial enclosure that is configured to be placed against a target surface;
a transparent window being integrated into a top surface of the housing, the transparent window being configured to allow for transmission of laser output to the target surface; and
an outlet port for establishing a negative pressure inside the housing, wherein air is drawn into the housing through a first inlet port, the air carries contaminants created during ablation of the target surface by the laser output out of the outlet port.

2. The system according to claim 1, wherein the housing comprises a gasket that spaces the housing apart from the target surface.

3. The system according to claim 1, further comprising a vacuum and contaminants sequestration system associated with the outlet port.

4. The system according to claim 1, wherein the first inlet port is a blade opening that is positioned on an end of the housing that is opposite from the outlet port.

5. The system according to claim 1, further comprising a second inlet port that is adjacent to the transparent window, the second inlet port being defined by an angled ledge inside the housing, the angled ledge directing air drawn into the second inlet port across the transparent window.

6. The system according to claim 1, further comprising an angled surface inside the housing that directs the air drawn across the transparent window downwardly towards the air drawn into the housing by the first inlet port.

7. The system according to claim 1, further comprising a third port that is vertically aligned with the transparent window, the third port providing an opening for the laser scan pattern to contact the target surface.

8. The system according to claim 1, wherein the first inlet port is coupled to a conduit or hose connected to an air handler to create a close circuit.

9. The system according to claim 8, further comprising an inert gas reservoir that is coupled to the first inlet port, the inert gas reservoir providing an inert gas that is mixed into the air drawn into the housing, the inert gas reducing ignition of the contaminants, wherein the inert gas purges and partially or fully replaces air from being drawn into the housing.

10. The system according to claim 1, wherein one or more sides of the housing are made of a transparent material that allows for the transmission of the laser output to an object within the housing.

11. A system comprising:
a housing that is configured to be placed against a target surface;
a geometrically shaped port such as a tubular port being integrated into a surface of the housing, the tubular port being configured to allow for transmission of a laser scan pattern to the target surface; and
an outlet port for drawing air inside the housing through the tubular port, the air carrying contaminants created during ablation of the target surface by the laser scan pattern out of the outlet port.

12. The system according to claim 11, wherein the housing comprises a gasket that spaces the housing apart from the target surface, the gasket being applied to lower edges of sides of the housing.

13. The system according to claim 11, further comprising a vacuum and contaminants sequestration system associated with the outlet port.

14. The system according to claim 11, wherein one or more sides of the housing are made of a transparent material that allows for the transmission of the laser scan pattern to an object within the housing.

15. A system comprising:
an enclosure having a top surface and sides;
a transparent window associated with the top surface, the transparent window allowing transmission of a laser scan pattern through the transparent window to a target surface; and
an outlet port for drawing air into an opening in the enclosure, the air mixing with and carrying away contaminants created during ablation of the target surface by the laser scan pattern, the air further cooling the target surface.

16. The system according to claim 15, wherein the opening comprises a slot or groove in one of the sides.

17. The system according to claim 15, further comprising another opening that is adjacent to the transparent window, the another opening being defined by an angled ledge inside the enclosure, the angled ledge directing air drawn into the another opening across the transparent window.

18. The system according to claim 15, wherein the opening is coupled to a conduit or hose connected to an air handler to create a close circuit.

19. The system according to claim 18, further comprising an inert gas reservoir that is coupled to the opening, the inert gas reservoir providing an inert gas that is mixed into the air drawn into the enclosure, the inert gas reducing ignition of the contaminants.

20. The system according to claim 15, wherein one or more sides of the enclosure are made of a transparent material that allows for transmission of the laser scan pattern to an object within the enclosure.
